(19) United States
(12) Patent Application Publication
(10) Pub. No.: US 2007/0174884 A1
(43) Pub. Date: Jul. 26, 2007

(54) Digital multimedia broadcasting system providing service number information

(75) Inventors: Hyun-Chul Kim, Suwon-si (KR); Young-Jip Kim, Suwon-si (KR)

Correspondence Address: THE FARRELL LAW FIRM, P.C., 333 EARLE OVINGTON BOULEVARD, SUITE 701, UNIONDALE, NY, 11553, US

(73) Assignee: Samsung Electronics Co., Ltd., Suwon-si (KR)

(21) Appl. No.: 11/581,278

(22) Filed: Oct. 16, 2006

(30) Foreign Application Priority Data
Jan. 24, 2006 (KR) 2006-7501

(51) Int. Cl. H04N 7/173; H04N 7/16; H04N 11/04; H04N 11/02; H04B 1/66

(52) U.S. Cl. 725/100; 725/131; 725/139; 375/240.25

(57) ABSTRACT

A terrestrial Digital Multimedia Broadcasting (DMB) system includes at least one broadcasting station for transmitting a digital broadcasting transmission frame containing predetermined service number information according to service, and a digital broadcasting receiver for receiving the digital broadcasting transmission frame and providing service number information contained in the received digital broadcasting frame according to service.

### PRIORITY

This application claims priority to an application filed with the Korean Intellectual Property Office on Jan. 24, 2006 and assigned Serial No. 2006-7501, the contents of which are incorporated herein by reference.

### BACKGROUND OF THE INVENTION

1. Field of the Invention

The present invention relates to a digital multimedia broadcasting system, and more particularly to a terrestrial digital multimedia broadcasting system, which transmits service number information.

2. Description of the Related Art

Digital Multimedia Broadcastings (DMBs) refer to broadcasting services that replace conventional analog broadcastings and provide users with high level service having superior sound and high definition. DMBs typically allow a user to receive video/audio and data broadcasting during movement and also to watch broadcasting through a DMB receiver.

DMBs may be classified into a satellite DMB and a terrestrial DMB, where the terrestrial DMB is standardized service based on Digital Audio Broadcasting. Generally, terrestrial DMB signals are formed by an ensemble unit including various services. Each service includes service components. For example, one ensemble may have plural video services, audio services, and data services.

FIG. 1 shows a configuration of an ensemble used for a terrestrial Digital Multimedia Broadcasting. The ensemble is allocated to one frequency, and includes plural services and service components that correspond to the plural services. For example, an ensemble having a label named “ensemble No. 1” includes services such as “alpha 1 radio,” “alpha 1 TV,” “beta radio,” “alpha 2 radio”, etc., that can each also include a plurality of service components.

Such services are contained in a portion of one ensemble frame which is a Main Service Channel (MSC). Structural information on the MSC may be found using Multiplex Configuration Information (MCI) and Service Information (SI) received through Fast Information Channel (FIC). For example, when the DMB receiver is tuned to select a certain ensemble, the DMB receiver does not extract and show services contained in the MSC of the ensemble, but analyzes the MCI and the SI in the FIC to show the services of the MSC.

The Korean terrestrial DMB will be described as an example. Table 1 indicates services in an ensemble allocated to the Korean terrestrial DMB.

TABLE 1

| | Channel Configuration Plan | | |
|---|---|---|---|
| Service provider | (Channel - Type - Transmission Rate) | Operation Planning | Broadcasting Field |
| Korea Broadcasting | KBS Mobile 1 - TV - 548k | Direct Operation | General |
| System | KBS Mobile 3 - Radio - 128k | Direct Operation | Music |
| | KMMB R - Radio - 128k | Hire | Living and Economy |
| | | (KMMB) | |
| | OZIC - Radio - 128k | Hire | Music |
| | | (CJ Media) | |
| | KBS Mobile 5 - Data - 220k | Direct Operation | General |
| Munwha | MBC DMB TV - TV - 548k | Direct Operation | General |
| Broadcasting Corp. | MBC DMB Radio - Radio - 128k | Direct Operation | General |
| | MBN Radio - Radio - 128k | Hire | Economy |
| | | (MBN) | |
| | Arirang English - Radio - 128k | Hire | Korean Culture |
| | | (Arirang TV) | |
| | MBC DMB Date - Date - 220k | Direct Operation | General |
| Seoul Broadcasting | SBS DMB TV - TV - 544k | Direct Operation | General |
| System | SBS DMB Radio - Radio - 128k | Direct Operation | General |
| | TBS DMB Radio - Radio - 128k | Hire | Traffic |
| | | (TBS - Seoul) | |
| | Gyounggi Broadcasting DMB - Radio - | Hire | Culture and Art |
| | 128k | (Gyounggi | |
| | | Broadcasting) | |
| | Hankyoreh DMB - Data - 96k | Hire | Job and Education |
| | | (The Hankyoreh) | |
| | LGT DMB - Data - 96k | Hire | Leisure and |
| | | (LG Telecom) | Entertainment |
| | SBS DMB Data - Data - 32k | Direct Operation | General |
| YTN DMB corp. | YTN Plus - TV - 512k | Direct operation | General |
| (provisional name) | TBN(Korea Transportation Broadcasting | Hire | Traffic |
| | Netowrk) - Radio - 160k | (Road Traffic | |
| | | Authority) | |
| | Satio + - Radio - 160k | Hire | General |
| | | (Satio) | |
| | YTN Premium - Data - 320k | Direct Operation | General |
| Korea DMB corp. | Korea DMB TV - TV - 548k | Direct Operation | General |
| (provisional name) | i4U - Radio - 128k | Hire | Living and Culture |
| | | (CBS) | |
| | Live4U - Radio - 128k | Hire | Exhibition, Music, and |
| | | (Music City Media) | Culture |
| | Korea DMB Data - Data - 348k | Direct Operation | General |
| KMMB corp. | KMMB - TV - 512k | Direct Operation | General |
| (provisional name) | KBS Mobile 2 - TV - 512k | Hire | Family and Culture |
| | | (KBS) | |
| | KMMB Data - Data - 128k | Direct Operation | General |

The Korean terrestrial DMB has six ensembles allocated thereto, including Korea Broadcasting System, Munwha Broadcasting Corp., Seoul Broadcasting System corp., YTN DMB corp., Korea DMB corp., and KMMB corp. Each ensemble has various services including seven video channels, thirteen audio channels, and seven data channels.

However, the above-mentioned terrestrial DMB does not provide a fixed channel number or service number to each service, but merely provides service channel names and service names, etc., which are currently usable. Thus, the DMB receiver allows a user to select a desired service through the channel names and service names, or the DMB receiver allocates numbers to the channel names and service names, respectively, so that the user can select a desired service.

Therefore, there is a problem in that it is difficult for the user, used to watching the broadcasting in which the channel number or service number is fixed, to select a certain service among the services of each DMB. In other words, for fixed type broadcasting in which the channel number or service number is fixed, the user can select the fixed channel number or service number. On the other hand, for DMB, since the channel number or service number is not fixed, the user must identify and select each channel number or service each time the user selects a service.

Recently, User Interfaces (UIs) have been developed for every DMB receiver in order for users to easily select DMB services. However, the UIs for DMB receivers provide different service selection methods that cause user inconvenience and confusion.

### SUMMARY OF THE INVENTION

Accordingly, the present invention has been made to solve the above-mentioned problems occurring in the prior art, and it is an object of the present invention to provide a terrestrial Digital Multimedia Broadcasting (DMB) system which can provide service numbers using Fast Information Channel (FIC) thereof.

It is another object of the present invention to provide a terrestrial Digital Multimedia Broadcasting (DMB) system, in which designated service numbers respectively can be allocated to each service of the terrestrial DMB to provide service number information, thereby making it possible for a user to conveniently select a corresponding terrestrial DMB service using the designated number.

In order to accomplish these objects, there is provided a terrestrial DMB system including at least one broadcasting station for transmitting a digital broadcasting transmission frame containing predetermined service number information according to service; and a digital broadcasting receiver for receiving the digital broadcasting transmission frame and providing service number information contained in the received digital broadcasting frame according to service.

### BRIEF DESCRIPTION OF THE DRAWINGS

The above and other objects, features, and advantages of the present invention will be more apparent from the following detailed description taken in conjunction with the accompanying drawings, in which:

FIG. 1 is a block diagram showing a configuration of an ensemble used for a terrestrial DMB;

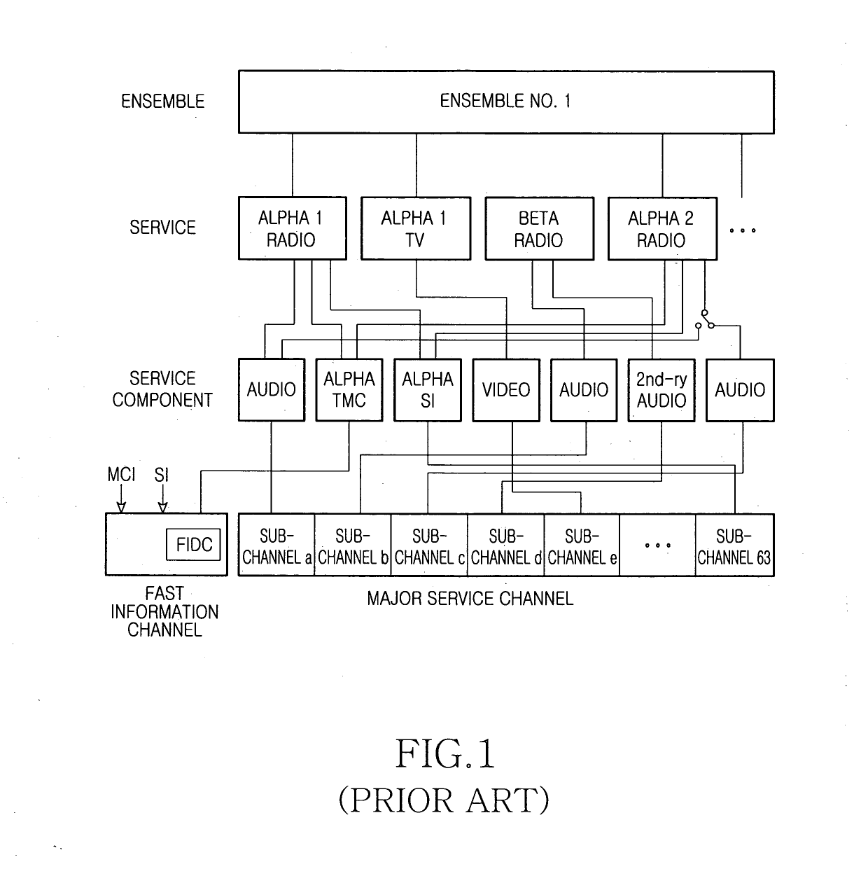

FIG. 2 is a view showing a configuration of a terrestrial DMB system according to the present invention;

FIG. 3 is a view showing a transmission frame for the terrestrial DMB according to the present invention;

FIG. 4 is a view showing a configuration of a fast information block of the transmission frame for the terrestrial DMB according to the present invention;

FIG. 5 is a view showing a configuration of a fast information group according to the present invention; and

FIG. 6 is a view showing an example of allocating service numbers according to the present invention.

### DETAILED DESCRIPTION OF THE PREFERRED EMBODIMENTS

Hereinafter, preferred embodiments of the present invention will be described with reference to the accompanying drawings. The same reference numerals are used to denote the same elements throughout the drawings. In the following description of the present invention, a detailed description of known functions and configurations incorporated herein is omitted to avoid making the subject matter of the present invention unclear.

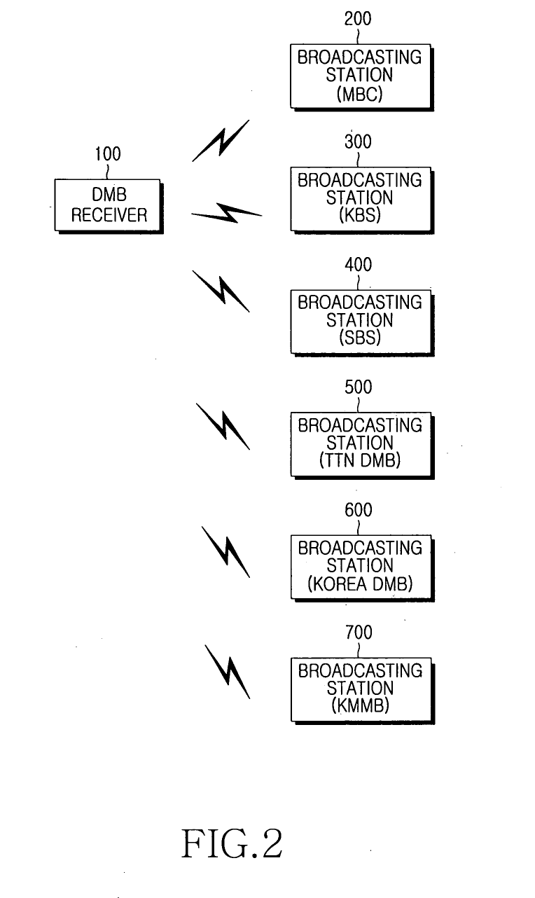

Referring to FIG. 2, a terrestrial Digital Multimedia Broadcasting (DMB) system according to the present invention includes broadcasting stations 200, 300, 400, 500, 600, and 700 which transmit digital broadcastings with a certain frequency, and DMB receiver 100 which receives digital broadcasting data from the broadcasting stations and outputs the broadcasting data through a display unit (not shown) and a speaker unit (not shown), thereby providing a user with digital broadcasting service. In such a terrestrial DMB system, broadcasting stations 200, 300, 400, 500, 600, and 700 respectively transmit the digital broadcasting through a certain terrestrial DMB transmission frame, while DMB receiver 100 receives the terrestrial DMB transmission frame, which in turn outputs the digital broadcasting contained in the frame.

In particular, broadcasting stations 200, 300, 400, 500, 600, and 700 respectively allocate service numbers, which are preset according to services, to the FIC in the transmission frame of the terrestrial DMB, and then transmit the DMB transmission frame. In the meantime, DMB receiver 100 receives the terrestrial DMB transmission frame and outputs the service number contained in the frame.

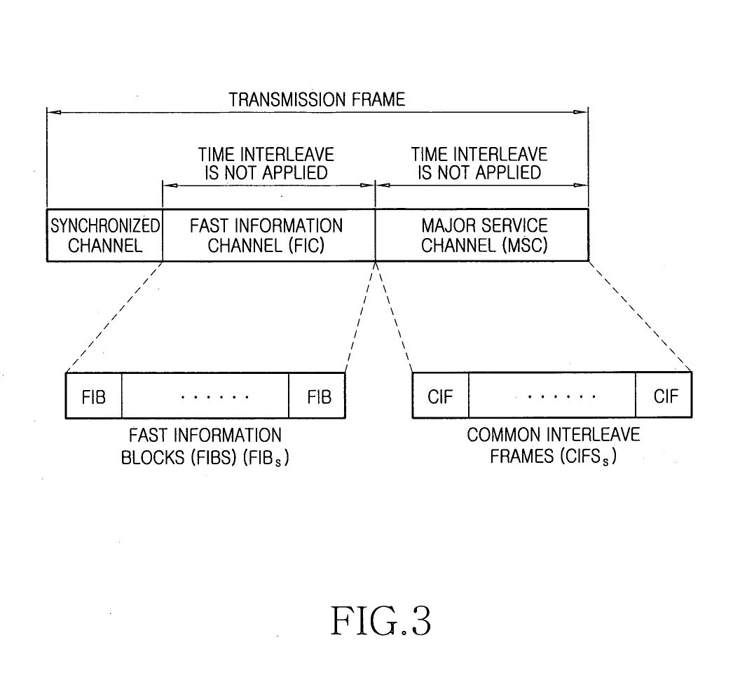

Referring to FIG. 3, the transmission frame in the terrestrial digital broadcasting has the same configuration as that of a transmission frame of digital radio broadcasting, and includes three channels such as a Synchronized Channel (SC), a Fast Information Channel (FIC), and a Major Service Channel (MSC).

The synchronized channel transmits information, such as transmission frame synchronization, automatic frequency control, channel state estimate, transmitter identification, etc., internally used by the transmission system.

The FIC has a dozen Fast Information Blocks (FIBs) having a rate of 96 ms, and carries out a function of transmitting control information used in analyzing the configuration of the main service channel. The key point of the control information is Multiplex Configuration Information which includes information on a multiplexed configuration, and if necessary, re-multiplex configuration. Other information, such as Service Information (SI), Conditional Access (CA) management information, and Fast Information Data Channel, may be contained in the FIC.

The MSC includes a Common Interleaved Frame (CIF) sequence. One CIF has data of 55,296 bits and is transmitted every 24 ms. The smallest unit by which the CIF can allocate an address is a Capacity Unit (CU). One CU includes 64 bits. Plural CUs are connected to one another, and form one main service channel in the form of a basic transmission unit referred to as a sub-channel. The main service channel has multiple service channels which include a video channel, an audio channel, and a data channel.

The configuration or length of a transmission frame of a terrestrial DMB constructed as described above may vary depending on a transmission mode. Table 2 shows the number of the FIB and CIF per transmission frame according to the transmission mode of the transmission frame as follows:

TABLE 2

| | | The number of | The number of |
|---|---|---|---|
| | Length of | FIB per | CIF per |
| Transmission | transmission | transmission | transmission |
| mode | frame | frame | frame |
| I | 96 ms | 12 | 4 |
| II | 24 ms | 3 | 1 |
| III | 24 ms | 4 | 1 |
| IV | 49 ms | 6 | 2 |

The terrestrial DMB provides a transmission mode using the FIB and the CIF, regardless of the kind of data transmitted through the FIC and the MSC.

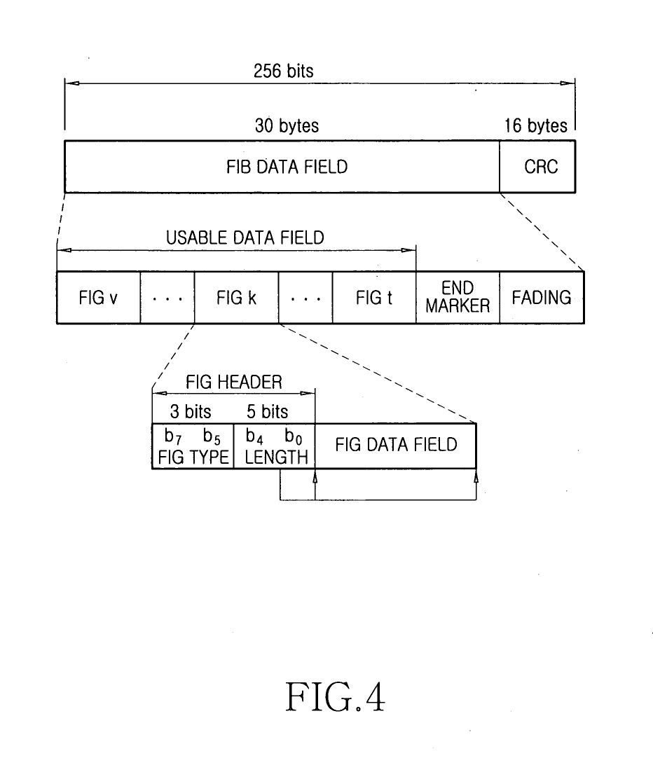

FIG. 4 shows a configuration of a FIB of a transmission frame for a terrestrial DMB according to the present invention. The FIB includes a plurality of Fast Information Groups (FIGs).

The groups may be classified into seven types based on information which each group has. Table 3 lists types of groups.

TABLE 3

| FIG type No. | FIG type | FIG application |
|---|---|---|
| 0 | 000 | MCI and a part of SI |
| 1 | 001 | Labels, etc. (a part of SI) |
| 2 | 010 | Reserved |
| 3 | 011 | Reserved |
| 4 | 100 | Reserved |
| 5 | 101 | FIC Data Channel |
| | | (FIDC) |
| 6 | 110 | Conditional Access (CA) |
| 7 | 111 | In house (except for |
| | | Length 31) |

According to the present invention, the FIG of the terrestrial DMB partially includes service number information in a type region, and is then transmitted.

For example, a type 7 group is used for In-house. In-house is a part which is defined to a non-predetermined part. Therefore, in the present invention, the service number information may be contained in the type 7 group and transmitted along with the type 7 group.

Further, extension regions 14 and 15 of the type 0 group are also parts which are not used. Therefore, in the present invention, the service number information may be contained in the extension region 14 and transmitted along with the extension region 14.

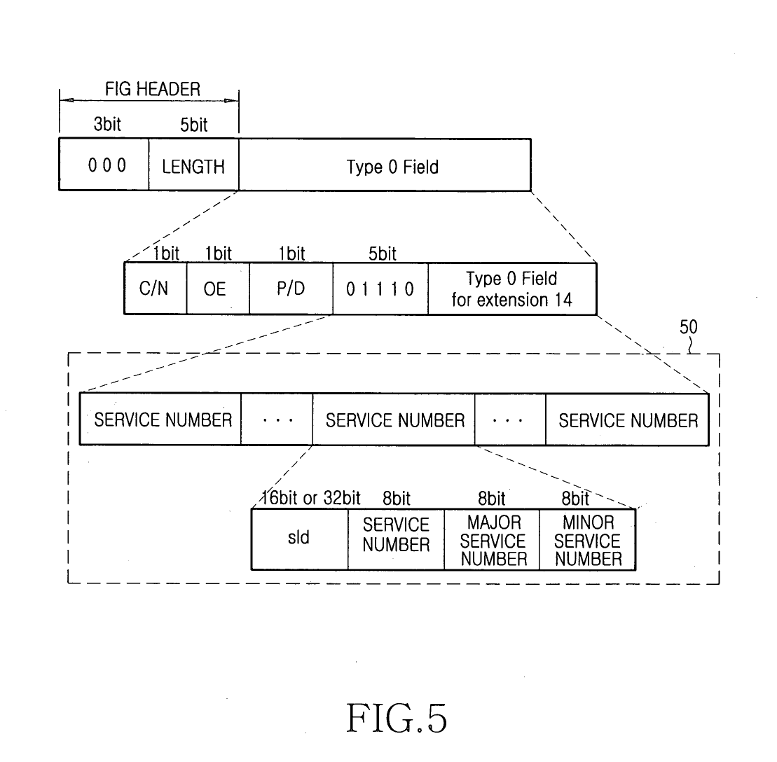

FIG. 5 is a view showing a field configuration of a fast information group according to the present invention. Configurations of a group header, C/N (Current/Next), OE (Other Ensemble), and P/D (Program Service/Data) are based on DAB (Digital Audio Broadcasting) standard (ETSI (European Telecommunications Standard Institute) EN (Endorsement) 300 401), so that service number information, such as a reference numeral 50, is contained in the extension region 14 of the type 0 group.

With respect to reference numeral 50, the extension region 14 of the type 0 group includes service number fields. On the other hand, the service number field includes a service identifier field, a service number field, a major number file, and a minor number field.

The service number field includes a service identification information to identify a service. In the case of an audio service, this service number field has a value of 16 bits, while in the case of video or data service, the service number field has a value of 32 bits.

The service number field indicates a service number assigned to a corresponding service. A user chooses a number corresponding to a service number to select the corresponding service.

The major number field shows a main service number of a corresponding service. The main service may be allocated based on an ensemble to which the corresponding service belongs, or depending on service types. That is, the allocation of the main service number may be changed according to the policy of the broadcasting station.

The minor number field refers to a sub-service number of the corresponding service. The sub-service number is used to distinguish services having identical main service numbers from one another. The different sub-service numbers are applied between service numbers having the same main service number. The allocation of the sub-service may also be change according to the policy of the broadcasting station.

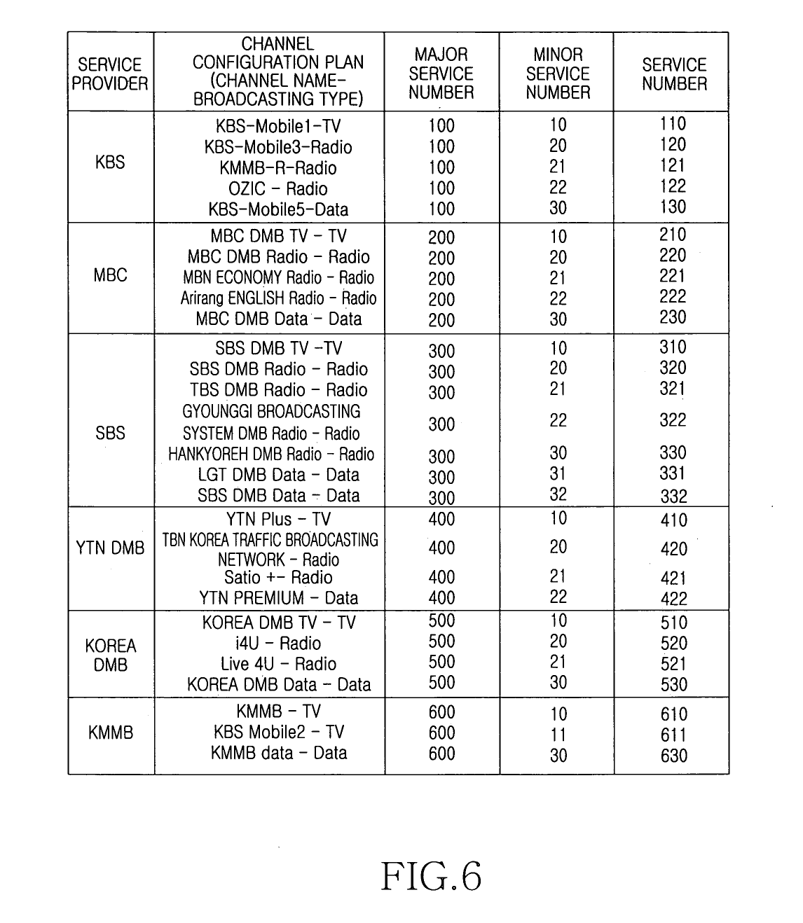

In FIG. 6, the main service numbers are allocated according to the ensembles, and the sub-service numbers are allocated according to the service types of the main service.

For video service, a sub-service number between ten and nineteen may be allocated. For audio service, a sub-service number between twenty and twenty-nine may be allocated, and for data service, a sub-service number between the thirty and thirty-nine may be allocated. The sum of the main service number and the sub service number may be allocated as the service number.

For example, when a service number is allocated as shown in FIG. 6, and a user intends to select a “MBC DMB TV” service, the user can push the number 210 which is a service number allocated to the “MBC DMB TV” in a DMB receiver to select the “MBC DMB TV”. When a service number is not allocated to the “MBC DMB TV,” the user must directly search for “MBC DMB TV” in a service list, and then select the service. However, when a service number is allocated, since the user pushes only the number “210,” and selects the “MBC DMB TV” service, this method is faster and more efficient than the above-mentioned method. Thus, when the major service number and the minor service number are efficiently allocated, it is possible to classify and search for service using the major service number and the minor service number. In the meantime, it will be understood that the relationship among the service number, the major service number and the minor service number can also be allocated differently according to the policy of the broadcasting station.

As described above, the present invention has an effect in which appropriate service number information can be supplied to each service.

Further, the present invention has another effect in which the designated service number is allocated to each service of the terrestrial DMB so that the user can conveniently select the corresponding service from the terrestrial DMB services, using the designated number.

Further, according to the present invention, there is an advantage in that the service number can be selected instead of selecting a service on a user interface of the DMB receiver, thereby removing problems associated with user inconvenience and confusion.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A terrestrial Digital Multimedia Broadcasting system, comprising:
at least one broadcasting station for transmitting a digital broadcasting transmission frame containing predetermined service number information according to service; and
a digital broadcasting receiver for receiving the digital broadcasting transmission frame and providing service number information contained in the received digital broadcasting frame according to service.

2. The terrestrial Digital Multimedia Broadcasting system as claimed in claim 1, wherein the service number information is contained in a Fast Information Group (FIG) region of the digital broadcasting transmission frame.

3. The terrestrial Digital Multimedia Broadcasting system as claimed in claim 1, wherein the service number information is contained in any one of In-house region of Fast Information Group (FIG) type 7, an extension region 14 of FIG type 0, and an extension region 15 of FIG type 0 among Fast Information Group regions.

4. The terrestrial Digital Multimedia Broadcasting system as claimed in claim 1, wherein the service number information includes a service identifier information, a service number, a major service number, and a minor service number.

5. The terrestrial Digital Multimedia Broadcasting system as claimed in claim 4, wherein the service identifier information includes information to identify an audio service, a video service, and a data service.

6. The terrestrial Digital Multimedia Broadcasting system as claimed in claim 4, wherein the service number is allocated to a corresponding service.

7. The terrestrial Digital Multimedia Broadcasting system as claimed in claim 4, wherein the major service number is allocated based on an ensemble to which a corresponding service belongs.

8. The terrestrial Digital Multimedia Broadcasting system as claimed in claim 4, wherein the major service number is allocated based on a service type to which a corresponding service belongs.

9. The terrestrial Digital Multimedia Broadcasting system as claimed in claim 4, wherein the minor service number is allocated as a value in order to distinguish services having an identical major service number from one another.

10. The terrestrial Digital Multimedia Broadcasting system as claimed in claim 2, wherein the service number information includes a service identifier information, a service number, a major service number, and a minor service number.

11. The terrestrial Digital Multimedia Broadcasting system as claimed in claim 10, wherein the service identifier information includes information to identify an audio service, a video service, and a data service.

12. The terrestrial Digital Multimedia Broadcasting system as claimed in claim 10, wherein the service number is allocated to a corresponding service.

13. The terrestrial Digital Multimedia Broadcasting system as claimed in claim 10, wherein the major service number is allocated based on an ensemble to which a

14. The terrestrial Digital Multimedia Broadcasting system as claimed in claim 10, wherein the major service number is allocated based on a service type to which a corresponding service belongs.

15. The terrestrial Digital Multimedia Broadcasting system as claimed in claim 10, wherein the minor service number is allocated as a value in order to distinguish services having an identical major service number from one another.

16. The terrestrial Digital Multimedia Broadcasting system as claimed in claim 3, wherein the service number information includes a service identifier information, a service number, a major service number, and a minor service number.

17. The terrestrial Digital Multimedia Broadcasting system as claimed in claim 16, wherein the service identifier information includes information to identify an audio service, a video service, and a data service.

18. The terrestrial Digital Multimedia Broadcasting system as claimed in claim 16, wherein the service number is allocated to a corresponding service.

19. The terrestrial Digital Multimedia Broadcasting system as claimed in claim 16, wherein the major service number is allocated based on an ensemble to which a corresponding service belongs.

20. The terrestrial Digital Multimedia Broadcasting system as claimed in claim 16, wherein the major service number is allocated based on a service type to which a corresponding service belongs.

21. The terrestrial Digital Multimedia Broadcasting system as claimed in claim 16, wherein the minor service number is allocated as a value in order to distinguish services having an identical major service number from one another.

22. The terrestrial Digital Multimedia Broadcasting system as claimed in claim 1, wherein the Digital Multimedia Broadcasting receiver provides a corresponding service as a user selects a service number.
